(19) United States
(12) Patent Application Publication
(10) Pub. No.: US 2026/0111726 A1
(43) Pub. Date: Apr. 23, 2026

(54) TRAINING A MACHINE LEARNING MODEL TO PREDICT IMAGES REPRESENTATIVE OF DEFECTS ON A SUBSTRATE

(71) Applicant: ASML NETHERLANDS B.V., Veldhoven (NL)

(72) Inventors: Jun TAO, San Jose, CA (US); Mu FENG, San Jose, CA (US); Yunbo GUO, San Jose, CA (US); Yen-Wen LU, Saratoga, CA (US); Lingling PU, San Jose, CA (US); Xu XIE, Fremont, CA (US); Christopher Alan SPENCE, Los Altos, CA (US); Chenji ZHANG, San Jose, CA (US); Liangjiang YU, Pleasanton, CA (US); Yu CAO, Saratoga, CA (US); Daekwon KANG, Pleasanton, CA (US); Jonathan LIU, Milpitas, CA (US); Chen ZHANG, San Jose, CA (US); Hongsuk NAM, Sunnyvale, CA (US)

(21) Appl. No.: 19/118,116

(22) PCT Filed: Sep. 21, 2023
(86) PCT No.: PCT/EP2023/076164

§ 371 Date: Apr. 3, 2025

Related U.S. Application Data
(60) Provisional application No. 63/418,578, filed on Oct. 23, 2022.

(51) Int. Cl. G06N 3/08

(52) U.S. Cl. CPC G06N 3/08

(57) ABSTRACT

A method for training a prediction model to generate a high-resolution image representing defects on a substrate from a low-resolution image of the substrate. The method includes inputting a first image and a reference image of defects on a substrate, which are representative of images captured using different image capture conditions, to a neural network. The neural network is executed to generate a predicted image in response to the first image. A loss function that is indicative of a difference between a defect distribution in the predicted image and a defect distribution in the reference image is calculated and the neural network is modified based on the loss function. The neural network may be trained until the loss function is minimized.

### CROSS-REFERENCE TO RELATED APPLICATIONS

This application claims priority of U.S. application 63/418,578 which was filed on Oct. 23, 2022 and which is incorporated herein in its entirety by reference.

### TECHNICAL FIELD

The disclosure herein relates to semiconductor manufacturing, and more particularly to inspecting a semiconductor substrate.

### BACKGROUND

A lithographic apparatus is a machine that applies a desired pattern onto a target portion of a substrate. The lithographic apparatus can be used, for example, in the manufacture of integrated circuits (ICs). For example, an IC chip in a smart phone, can be as small as a person's thumbnail, and may include over 2 billion transistors. Making an IC is a complex and time-consuming process, with circuit components in different layers and including hundreds of individual steps. Errors in even one step have the potential to result in problems with the final IC and can cause device failure. High process yield and high wafer throughput can be impacted by the presence of defects.

Metrology processes are used at various steps during a patterning process to monitor and/or control the process. For example, metrology processes are used to measure one or more characteristics of a substrate, such as a relative location (e.g., registration, overlay, alignment, etc.) or dimension (e.g., line width, critical dimension (CD), thickness, etc.) of features formed on the substrate during the patterning process or stochastic variation, such that, for example, the performance of the patterning process can be determined from the one or more characteristics. If the one or more characteristics are unacceptable (e.g., out of a predetermined range for the characteristic(s)), one or more variables of the patterning process may be designed or altered, e.g., based on the measurements of the one or more characteristics, such that substrates manufactured by the patterning process have an acceptable characteristic(s).

Wafer inspection is a process to find a defect on a wafer. A wafer inspection tool may be used to perform the wafer inspection. In the inspection process, the wafer inspection tool takes a photo of a die. Then, the inspection tool takes a photo of another die and compares them. If there's a change, that's generally a defect. The inspection tool may find defects and also detect a false defect what is commonly called as a “nuisance.” In more advanced nodes, the nuisances and defects appear to be bunched together on the map and it's difficult to distinguish the differences between the two. Detection of nuisances from the defects may typically require high quality or high-resolution images to find a defect of interest. However, a significant amount of time is consumed in capturing a high-resolution image (hence referred to as a “slow scan image”).

Image capture time for a low-quality or low-resolution image is much faster (hence referred to as a “fast scan image”) than that of the high-quality image but may not help in identifying the defects from nuisances due to the poor quality. Machine learning (ML) models provide the solutions to improve the image quality from low to high quality with an acceptable defect capture rate (defect to nuisance ratio). ML models may require low-resolution and high-resolution image pairs as training data to convert a low-resolution image to high resolution image.

### BRIEF SUMMARY

In some aspects, the techniques described herein relate to a non-transitory computer-readable medium having instructions that, when executed by a computer, cause the computer to execute a method for training a machine learning model to generate an image representing defects on a substrate. The method includes: inputting a first image and a reference image representative of images captured using different image capture conditions to a neural network, the first image and the reference image indicate defects on a substrate patterned with a target layout; generating, using the neural network, a predicted image in response to the first image; computing a loss function that is indicative of a difference between a defect distribution in the predicted image and a defect distribution in the reference image; and modifying the neural network based on the loss function.

In some aspects, the techniques described herein relate to a non-transitory computer-readable medium having instructions that, when executed by a computer, cause the computer to execute a method for training a machine learning model to generate an image representing defects on a substrate. The method includes: inputting a first image and a reference image representative of images captured using different image capture conditions to a neural network, the first image and the reference image representative of defects on a substrate patterned with a target layout; generating, using the neural network, a predicted image in response to the first image; computing a loss function that is indicative of a difference between a first set of feature vectors of the predicted image and a second set of feature vectors of the reference image; and modifying the neural network based on the loss function.

In some aspects, the techniques described herein relate to a non-transitory computer-readable medium having instructions that, when executed by a computer, cause the computer to execute a method for training a machine learning model to generate an image indicative of defects on a substrate. The method includes: obtaining a first image and a reference image captured using different image capture conditions, the first image and the reference image representative of defects on a substrate patterned with a target layout; adding a defect to the first image and the reference image to generate an updated first image and an updated reference image; and training a neural network with the updated first image and the updated reference image to convert the updated first image to a predicted image using the updated reference image, wherein the predicted image is representative of defects on the substrate and corresponds to an image capture condition of the reference image.

In some aspects, the techniques described herein relate to a non-transitory computer-readable medium having instructions that, when executed by a computer, cause the computer to execute a method for training a machine learning model to generate an image indicative of defects on a substrate. The method includes: obtaining a first image and a reference image captured using different image capture conditions, the first image and the reference image representative of defects on a substrate patterned with a target layout; modifying an area of the reference image that is representative of a defect to generate an updated reference image; and training a neural network to convert the first image to a predicted image using the updated reference image, wherein the predicted image is representative of defects on the substrate and corresponds to an image capture condition of the reference image.

In some aspects, the techniques described herein relate to a non-transitory computer-readable medium having instructions that, when executed by a computer, cause the computer to execute a method for training a machine learning model to generate an image indicative of defects on a substrate. The method includes: obtaining multiple image pairs, wherein each image pair includes a first image and a reference image captured using different image capture conditions, the first image and the reference image representative of defects on a substrate patterned with a target layout; determining a defect detection probability of reference images of the image pairs; selecting a subset of the image pairs based on the defect detection probability; and training a neural network with subset of image pairs to convert the first image of an image pair of the subset of image pairs to a predicted image using the reference image of the image pair, wherein the predicted image is representative of defects on the substrate and corresponds to an image capture condition of the reference image.

In some aspects, the techniques described herein relate to a method for training a machine learning model to generate an image representing defects on a substrate. The method includes: inputting a first image and a reference image representative of images captured using different image capture conditions to a neural network, the first image and the reference image indicate defects on a substrate patterned with a target layout; generating, using the neural network, a predicted image in response to the first image; computing a loss function that is indicative of a difference between a defect distribution in the predicted image and a defect distribution in the reference image; and modifying the neural network based on the loss function.

In some aspects, the techniques described herein relate to a method for training a machine learning model to generate an image representing defects on a substrate. The method includes: inputting a first image and a reference image representative of images captured using different image capture conditions to a neural network, the first image and the reference image representative of defects on a substrate patterned with a target layout; generating, using the neural network, a predicted image in response to the first image; computing a loss function that is indicative of a difference between a first set of feature vectors of the predicted image and a second set of feature vectors of the reference image; and modifying the neural network based on the loss function.

In some aspects, the techniques described herein relate to an apparatus for training a machine learning model to generate an image representing defects on a substrate. The apparatus includes: a memory storing a set of instructions; and a processor configured to execute the set of instructions to cause the apparatus to perform a method of: inputting a first image and a reference image representative of images captured using different image capture conditions to a neural network, the first image and the reference image indicate defects on a substrate patterned with a target layout; generating, using the neural network, a predicted image in response to the first image; computing a loss function that is indicative of a difference between a defect distribution in the predicted image and a defect distribution in the reference image; and modifying the neural network based on the loss function.

In some aspects, the techniques described herein relate to an apparatus for training a machine learning model to generate an image representing defects on a substrate. The apparatus includes: a memory storing a set of instructions; and a processor configured to execute the set of instructions to cause the apparatus to perform a method of: inputting a first image and a reference image representative of images captured using different image capture conditions to a neural network, the first image and the reference image representative of defects on a substrate patterned with a target layout; generating, using the neural network, a predicted image in response to the first image; computing a loss function that is indicative of a difference between a first set of feature vectors of the predicted image and a second set of feature vectors of the reference image; and modifying the neural network based on the loss function.

### BRIEF DESCRIPTION OF THE DRAWINGS

Embodiments will now be described, by way of example only, with reference to the accompanying drawings in which:

FIG. 1 is a schematic diagram illustrating an exemplary electron beam inspection (EBI) system, according to an embodiment.

FIG. 2 is a schematic diagram of an exemplary electron beam tool, according to an embodiment.

FIG. 3 depicts a schematic representation of holistic lithography, representing a cooperation between three technologies to optimize semiconductor manufacturing, according to an embodiment.

FIG. 4 is a block diagram of a system for enhancing defects in images for use in training a prediction model to convert a fast scan image to a slow scan image, consistent with various embodiments.

FIG. 5 is a flow diagram of a method for enhancing defects in images for use in training a prediction model to convert a fast scan image to a slow scan image, consistent with various embodiments.

FIG. 6 is a block diagram of a system for enhancing defects in images for use in training a prediction model to convert a fast scan image to a slow scan image, consistent with various embodiments.

FIG. 7 is a flow diagram of a method for enhancing defects in images for use in training a prediction model to convert a fast scan image to a slow scan image, consistent with various embodiments.

FIG. 8 is a block diagram of a system for training a prediction model to convert a fast scan image to a slow scan image based on defect distribution in images of a substrate, consistent with various embodiments.

FIG. 9 is a flow diagram of a method for training a prediction model to convert a fast scan image to a slow scan image based on defect distribution in images of a substrate, consistent with various embodiments.

FIG. 10 is a block diagram of a system for training a prediction model to convert a fast scan image to a slow scan image based on classifier feature maps associated with images of a substrate, consistent with various embodiments.

FIG. 11 is a flow diagram of a method for training a prediction model to convert a fast scan image to a slow scan image based on classifier feature maps associated with images of a substrate, consistent with various embodiments.

FIG. 12 is a block diagram of a system for selecting images for use in training a prediction model to convert a fast scan image to a slow scan image, consistent with various embodiments.

FIG. 13 is a flow diagram of a method for selecting images for use in training a prediction model to convert a fast scan image to a slow scan image, consistent with various embodiments.

FIG. 14 is a block diagram of an example computer system, according to an embodiment.

Embodiments will now be described in detail with reference to the drawings, which are provided as illustrative examples so as to enable those skilled in the art to practice the embodiments. Notably, the figures and examples below are not meant to limit the scope to a single embodiment, but other embodiments are possible by way of interchange of some or all of the described or illustrated elements. Wherever convenient, the same reference numbers will be used throughout the drawings to refer to same or like parts. Where certain elements of these embodiments can be partially or fully implemented using known components, only those portions of such known components that are necessary for an understanding of the embodiments will be described, and detailed descriptions of other portions of such known components will be omitted so as not to obscure the description of the embodiments. In the present specification, an embodiment showing a singular component should not be considered limiting; rather, the scope is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the scope encompasses present and future known equivalents to the components referred to herein by way of illustration.

### DETAILED DESCRIPTION

A lithographic apparatus is a machine that applies a desired pattern onto a target portion of a substrate. This process of transferring the desired pattern to the substrate is called a patterning process. The patterning process can include a patterning step to transfer a pattern from a patterning device (such as a mask) to the substrate. Various variations (e.g., variations in the patterning process or the lithographic apparatus) can potentially limit lithography implementation for semiconductor high volume manufacturing (HVM). High resolution images (e.g., images with a resolution above a specified threshold) of a substrate, such as images obtained using a scanning electron microscope (SEM), may be inspected for determining any defects in the patterning process.

Conventional techniques employ various computational methods for obtaining the high resolution (HR) images of defects on the substrate. For example, machine learning (ML) models are employed to generate HR images of a defect on the substrate based on the low resolution (LR) images (e.g., images with a resolution below the specified threshold) of the defect (e.g., obtained using the SEM). For example, a low resolution image is captured in a fast speed beam scanning condition, while a corresponding HR image is captured at a much slower speed. The ML models are trained using LR and HR image pairs of the defect region to predict a HR image of the defect region based on LR image. However, the number of image pairs of the defect region available is typically limited and insufficient for use in training the ML model. In some cases, images are of poor quality and the defects are so weak they are not useful in training the ML model. In some cases, the conventional training methods do not consider a defect score associated with the defects in training the ML models and therefore, some defects are not captured or some false defects are captured, thereby resulting in a decreased capture rate of the defects. In some cases, the conventional training methods do not consider characterization features associated with the defects or nuisance in training the ML models and therefore, some defects are not captured, or some nuisances are captured as defects, thereby resulting in a decreased capture rate of the defects. The characterization features can be features of defects or nuisance extracted using characterization feature extraction filters. For example, some characterization feature extraction filters such as low-pass filter or wavelet filter capture the low frequency and high frequency attributes of the defects or nuisance. In some cases, for example, because the training data coverage is not sufficient, the training process may not be focused adequately on training the ML model with respect to scenarios where the defects and nuisance are difficult to differentiate. For example, if the image pairs are selected randomly, the selected image pairs may excessively include nuisance and defects that are easy to differentiate and causing the ML model to underperform in differentiating the nuisance from the defect.

Disclosed are embodiments of training a prediction model (e.g., an ML model) to generate high resolution images of a defect on substrate offering an improved capture rate of defects. In an embodiment, the number of training images with defects is enhanced by adding one more defects to the training images (e.g., by a user) and training the prediction model with the updated images. For example, a fast scan image obtained using a fast scan image capture condition (e.g., an LR image of the defect region on a substrate) and a slow scan image obtained using a slow scan image capture condition (e.g., a corresponding HR image of the defect region) are modified by adding defects to the images and the prediction model is trained with a number of such updated image pairs to convert a fast scan image to a slow scan image.

In an embodiment, the problem with weak signals of the defect may be overcome by enhancing the defect signals in the images. For example, a contrast of the defect region may be enhanced in the slow scan image and a prediction model is trained with a number of such updated image pairs to convert a fast scan image to a slow scan image.

In an embodiment, a capture rate of the defects (e.g., a ratio of a number of actual or “golden” defects captured to a total number of defects captured) may be improved by training a prediction model based on defect distribution associated with the training image pairs. For example, a defect score that is indicative of a probability of presence of a defect in a portion of an image is determined for each of the fast scan and slow scan image and a loss function of a prediction model is customized to include a difference between the defect scores of the fast scan and slow scan images, and the prediction model may be trained based on the customized loss function to convert a fast scan image to a slow scan image.

In an embodiment, the capture rate of the defects may be improved by training a prediction model based on classifier feature maps associated with the training image pairs. For example, a set of characterization feature vectors, which are representative of characterization features of a defect or nuisance, are extracted from the slow scan and fast scan images using characterization feature extraction filters (e.g., wavelet filter, low-pass filter, etc.). A loss function of a prediction model is customized to include a difference between the classifier feature maps (e.g., image generated based on characterization feature vectors) of the fast scan and slow scan images, and the prediction model may be trained based on the customized loss function to convert a fast scan image to a slow scan image.

In an embodiment, the capture rate of the defects may also be improved by selecting the training image pairs based on defect scores associated with the actual defects and nuisance. For example, a defect candidate having a defect score below a first threshold score and a defect score above a second threshold score may be easily categorized into a nuisance and defect, respectively, as opposed to defect candidates having a defect score in a “target” range that lies between the first threshold score and the second threshold score. By selecting those image pairs that have defect scores in the target range and training a prediction model with the selected image pairs the prediction model can be configured to convert a fast scan image to a slow scan image without missing any actual defects and ignoring nuisance, thereby improving the capture rate.

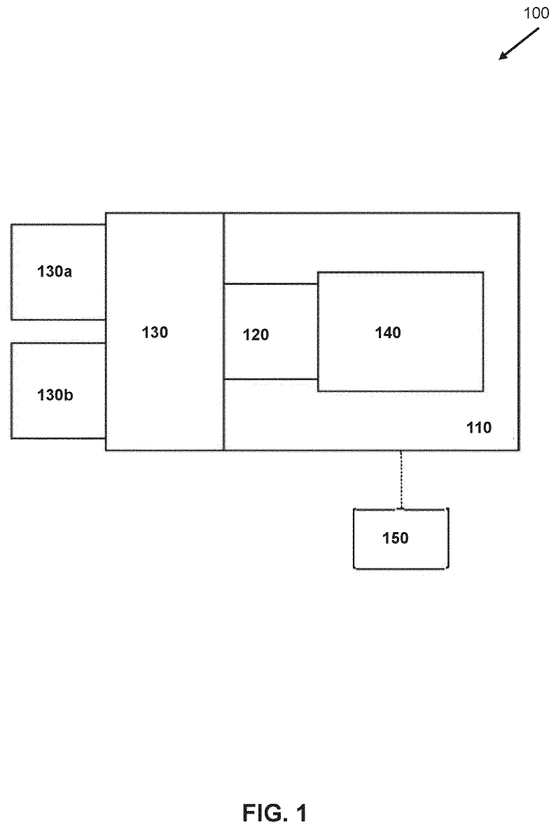

Reference is now made to FIG. 1, which illustrates an exemplary electron beam inspection (EBI) system 100 consistent with embodiments of the present disclosure. As shown in FIG. 1, EBI system 100 includes a main chamber 110, a load-lock chamber 120, an electron beam tool 140, and an equipment front end module (EFEM) 130. Electron beam tool 140 is located within main chamber 110. The exemplary EBI system 100 may be a single or multi-beam system. While the description and drawings are directed to an electron beam, it is appreciated that the embodiments are not used to limit the present disclosure to specific charged particles.

EFEM 130 includes a first loading port 130a and a second loading port 130b. EFEM 130 may include additional loading port(s). First loading port 130a and second loading port 130b receive wafer front opening unified pods (FOUPs) that contain wafers (e.g., semiconductor wafers or wafers made of other material(s)) or samples to be inspected (wafers and samples are collectively referred to as “wafers” hereafter). One or more robot arms (not shown) in EFEM 130 transport the wafers to load-lock chamber 120.

Load-lock chamber 120 is connected to a load/lock vacuum pump system (not shown), which removes gas molecules in load-lock chamber 120 to reach a first pressure below the atmospheric pressure. After reaching the first pressure, one or more robot arms (not shown) transport the wafer from load-lock chamber 120 to main chamber 110. Main chamber 110 is connected to a main chamber vacuum pump system (not shown), which removes gas molecules in main chamber 110 to reach a second pressure below the first pressure. After reaching the second pressure, the wafer is subject to inspection by electron beam tool 140. In an embodiment, electron beam tool 140 may comprise a single-beam inspection tool.

Controller 150 may be electronically connected to electron beam tool 140 and may be electronically connected to other components as well. Controller 150 may be a computer configured to execute various controls of EBI system 100. Controller 150 may also include processing circuitry configured to execute various signal and image processing functions. While controller 150 is shown in FIG. 1 as being outside of the structure that includes main chamber 110, load-lock chamber 120, and EFEM 130, it is appreciated that controller 150 can be part of the structure.

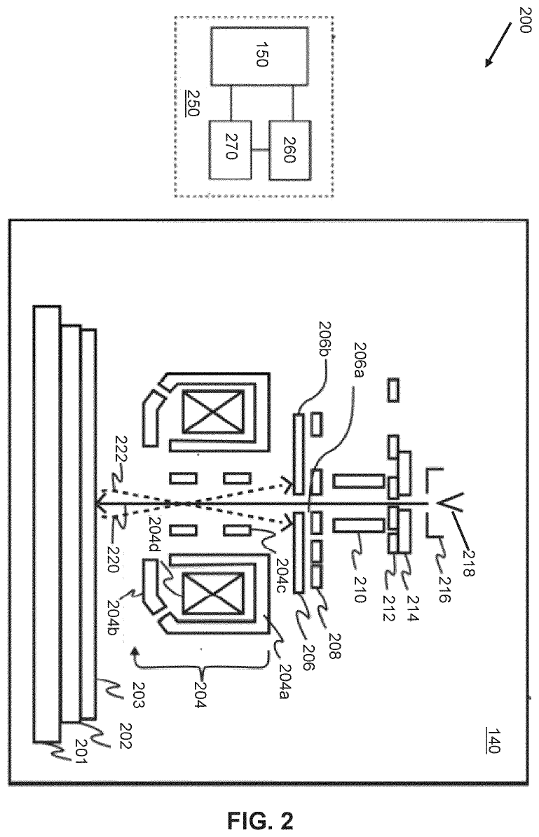

FIG. 2 illustrates schematic diagram of an exemplary imaging system 200 according to embodiments of the present disclosure. Electron beam tool 140 of FIG. 2 may be configured for use in EBI system 100. Electron beam tool 140 may be a single beam apparatus or a multi-beam apparatus. As shown in FIG. 2, electron beam tool 140 includes a motorized sample stage 201, and a wafer holder 202 supported by motorized sample stage 201 to hold a wafer 203 to be inspected. Electron beam tool 140 further includes an objective lens assembly 204, an electron detector 206 (which includes electron sensor surfaces 206a and 206b), an objective aperture 208, a condenser lens 210, a beam limit aperture 212, a gun aperture 214, an anode 216, and a cathode 218. Objective lens assembly 204, in an embodiment, may include a modified swing objective retarding immersion lens (SORIL), which includes a pole piece 204a, a control electrode 204b, a deflector 204c, and an exciting coil 204d. Electron beam tool 140 may additionally include an Energy Dispersive X-ray Spectrometer (EDS) detector (not shown) to characterize the materials on wafer 203.

A primary electron beam 220 is emitted from cathode 218 by applying a voltage between anode 216 and cathode 218. Primary electron beam 220 passes through gun aperture 214 and beam limit aperture 212, both of which may determine the size of electron beam entering condenser lens 210, which resides below beam limit aperture 212. Condenser lens 210 focuses primary electron beam 220 before the beam enters objective aperture 208 to set the size of the electron beam before entering objective lens assembly 204. Deflector 204c deflects primary electron beam 220 to facilitate beam scanning on the wafer. For example, in a scanning process, deflector 204c may be controlled to deflect primary electron beam 220 sequentially onto different locations of top surface of wafer 203 at different time points, to provide data for image reconstruction for different parts of wafer 203. Moreover, deflector 204c may also be controlled to deflect primary electron beam 220 onto different sides of wafer 203 at a particular location, at different time points, to provide data for stereo image reconstruction of the wafer structure at that location. Further, in an embodiment, anode 216 and cathode 218 may be configured to generate multiple primary electron beams 220, and electron beam tool 140 may include a plurality of deflectors 204c to project the multiple primary electron beams 220 to different parts/sides of the wafer at the same time, to provide data for image reconstruction for different parts of wafer 203.

Exciting coil 204d and pole piece 204a generate a magnetic field that begins at one end of pole piece 204a and terminates at the other end of pole piece 204a. A part of wafer 203 being scanned by primary electron beam 220 may be immersed in the magnetic field and may be electrically charged, which, in turn, creates an electric field. The electric field reduces the energy of impinging primary electron beam 220 near the surface of wafer 203 before it collides with wafer 203. Control electrode 204b, being electrically isolated from pole piece 204a, controls an electric field on wafer 203 to prevent micro-arching of wafer 203 and to ensure proper beam focus.

A secondary electron beam 222 may be emitted from the part of wafer 203 upon receiving primary electron beam 220. Secondary electron beam 222 may form a beam spot on sensor surfaces 206a and 206b of electron detector 206. Electron detector 206 may generate a signal (e.g., a voltage, a current, etc.) that represents an intensity of the beam spot, and provide the signal to an image processing system 250. The intensity of secondary electron beam 222, and the resultant beam spot, may vary according to the external or internal structure of wafer 203. Moreover, as discussed above, primary electron beam 220 may be projected onto different locations of the top surface of the wafer or different sides of the wafer at a particular location, to generate secondary electron beams 222 (and the resultant beam spot) of different intensities. Therefore, by mapping the intensities of the beam spots with the locations of wafer 203, the processing system may reconstruct an image that reflects the internal or surface structures of wafer 203.

Imaging system 200 may be used for inspecting a wafer 203 on sample stage 201, and comprises an electron beam tool 140, as discussed above. Imaging system 200 may also comprise an image processing system 250 that includes an image acquirer 260, storage 270, and controller 150. Image acquirer 260 may comprise one or more processors. For example, image acquirer 260 may comprise a computer, server, mainframe host, terminals, personal computer, any kind of mobile computing devices, and the like, or a combination thereof. Image acquirer 260 may connect with a detector 206 of electron beam tool 140 through a medium such as an electrical conductor, optical fiber cable, portable storage media, IR, Bluetooth, internet, wireless network, wireless radio, or a combination thereof. Image acquirer 260 may receive a signal from detector 206 and may construct an image. Image acquirer 260 may thus acquire images of wafer 203. Image acquirer 260 may also perform various post-processing functions, such as generating contours, superimposing indicators on an acquired image, and the like. Image acquirer 260 may be configured to perform adjustments of brightness and contrast, etc. of acquired images. Storage 270 may be a storage medium such as a hard disk, cloud storage, random access memory (RAM), other types of computer readable memory, and the like. Storage 270 may be coupled with image acquirer 260 and may be used for saving scanned raw image data as original images, and post-processed images. Image acquirer 260 and storage 270 may be connected to controller 150. In an embodiment, image acquirer 260, storage 270, and controller 150 may be integrated together as one control unit.

In an embodiment, image acquirer 260 may acquire one or more images of a sample based on an imaging signal received from detector 206. An imaging signal may correspond to a scanning operation for conducting charged particle imaging. An acquired image may be a single image comprising a plurality of imaging areas. The single image may be stored in storage 270. The single image may be an original image that may be divided into a plurality of regions. Each of the regions may comprise one imaging area containing a feature of wafer 203.

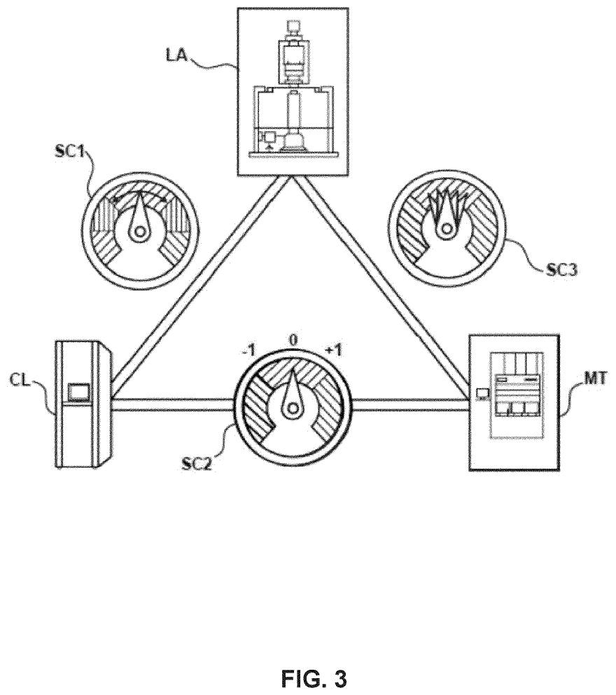

FIG. 3 depicts a schematic representation of holistic lithography, representing a cooperation between three technologies to optimize semiconductor manufacturing. Typically, the patterning process in a lithographic apparatus LA is one of the most critical steps in the processing which requires high accuracy of dimensioning and placement of structures on the substrate W (FIG. 1). To ensure this high accuracy, three systems (in this example) may be combined in a so called “holistic” control environment as schematically depicted in FIG. 3. One of these systems is the lithographic apparatus LA which is (virtually) connected to a metrology apparatus (e.g., a metrology tool) MT (a second system), and to a computer system CL (a third system). A “holistic” environment may be configured to optimize the cooperation between these three systems to enhance the overall process window and provide tight control loops to ensure that the patterning performed by the lithographic apparatus LA stays within a process window. The process window defines a range of process parameters (e.g., dose, focus, overlay) within which a specific manufacturing process yields a defined result (e.g., a functional semiconductor device)—typically within which the process parameters in the lithographic process or patterning process are allowed to vary.

The computer system CL may use (part of) the design layout to be patterned to predict which resolution enhancement techniques to use and to perform computational lithography simulations and calculations to determine which mask layout and lithographic apparatus settings achieve the largest overall process window of the patterning process (depicted in FIG. 2 by the double arrow in the first scale SC1). Typically, the resolution enhancement techniques are arranged to match the patterning possibilities of the lithographic apparatus LA. The computer system CL may also be used to detect where within the process window the lithographic apparatus LA is currently operating (e.g., using input from the metrology tool MT) to predict whether defects may be present due to, for example, sub-optimal processing (depicted in FIG. 2 by the arrow pointing “0” in the second scale SC2).

The metrology apparatus (tool) MT may provide input to the computer system CL to enable accurate simulations and predictions, and may provide feedback to the lithographic apparatus LA to identify possible drifts, e.g., in a calibration status of the lithographic apparatus LA (depicted in FIG. 3 by the multiple arrows in the third scale SC3).

The following paragraphs describe a system and a method for training a prediction model (e.g., an ML model) to convert a low-resolution image of a defect on a substrate to a high-resolution image which can be used to improve capture rate of defects. Note that the prediction models discussed below may be implemented as an ML model (e.g., a neural network), a non-machine learning model, a physical model, a statistical model, an analytics model, a rule-based model, or any other empirical model. A training image pair input to the prediction model may include a first image of a substrate captured in a first image capture condition and a second image of the substrate captured in a second image capture condition. The second image may be used as a reference or ground truth image in training the prediction model. In an embodiment, the first image is a low-resolution image of an area of a substrate captured using a fast scan mode of an inspection system (and hence referred to as a “fast scan image”), and the second image/ground truth/reference image is a corresponding high-resolution image of the area of the substrate captured using a slow scan mode of the inspection system (hence referred to as a “slow scan image”). Typically, the fast scan mode captures an image of a substrate faster than the slow scan mode of an inspection system (e.g., inspection system of FIGS. 1-3), and a fast scan image is typically of a lower resolution than that of the slow scan image. The training image pair or at least one of the fast scan or slow scan images may be obtained using a SEM or other imaging system (e.g., inspection system described at least with reference to FIGS. 1-3) or may be obtained using other methods such as simulation. The following paragraphs use the fast scan and slow scan images as examples of the first image and the second image, respectively, but the first and second images are not restricted to the fast and slow scan images. The first and second images may also be obtained using other image capture conditions. For example, the first image may be a simulated image and the second image be a higher resolution version of the simulated image. In an embodiment, a low-resolution (LR) image has a resolution below a specified resolution threshold and a high-resolution image (HR) has a resolution above the specified resolution threshold.

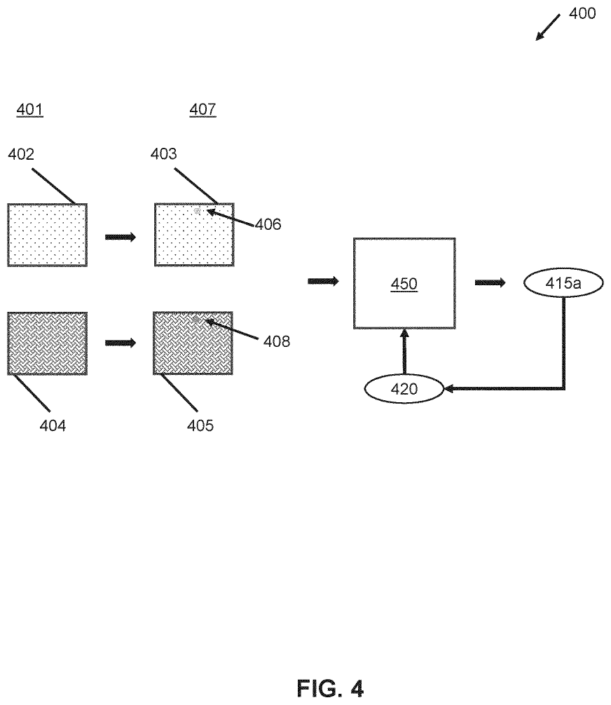

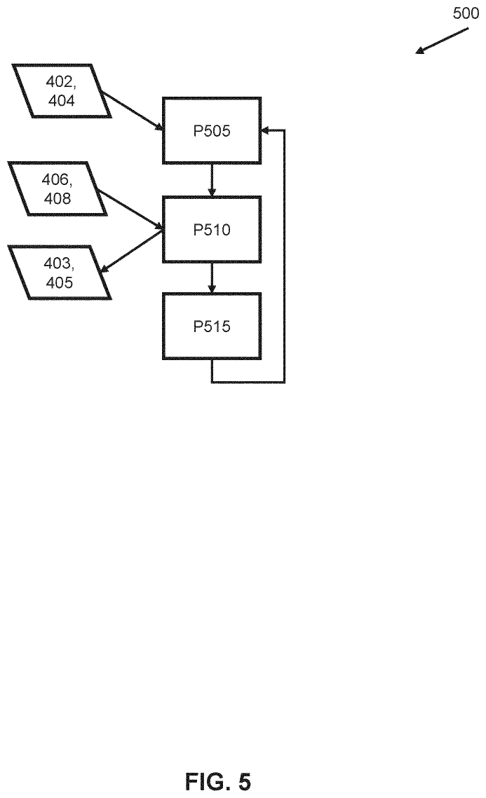

FIG. 4 is a block diagram of an exemplary system 400 for enhancing defects in images for use in training a prediction model to convert a fast scan image to a slow scan image, consistent with various embodiments. FIG. 5 is a flow diagram of an exemplary method 500 for enhancing defects in images for use in training a prediction model to convert a fast scan image to a slow scan image, consistent with various embodiments.

At process P505, an image pair 401 having a fast scan image 402 of an area of a substrate and a corresponding slow scan image 404 of the area of the substrate is obtained. The fast scan image 402 and the slow scan image 404 may or may not indicate any defects on the substrate. In the example of FIG. 4, the image pair 401 does not indicate any defects on the substrate.

At process P510, one or more defects are added to the image pair 401. In an embodiment, adding a defect to an image includes editing a portion of the image to add a marker representing a defect, or to match with a portion of any reference image of the substrate that is indicative of a defect on the substrate. For example, the fast scan image 402 is edited to add a defect 406, thus, generating an updated fast scan image 403, and the slow scan image 404 is edited to add a defect 408, thus, generating an updated slow scan image 405. The defects may be added to the images by a user or other means. In an embodiment, a statistical analysis may be performed on the defects in the actual SEM images of a substrate to determine various attributes such as a shape, size, intensity, signal value (e.g., pixel value of a location of the defect in the image), etc. An artificial defect may be added to the image pair 401 such that one or more of the attributes of the artificial defect match with the attributes determined based on the statistical analysis. In an embodiment, the attributes of the artificial defect may be randomly chosen from the attributes of the actual defects determined based on the statistical analysis.

At process P515, an image generator 450 is trained with an updated image pair 407 to generate a predicted slow scan image 415a from the updated fast scan image 403 using the updated slow scan image 405 as a ground truth image or reference image. The image generator 450 may be implemented as a prediction model. The image generator 450 generates a predicted slow scan image 415a corresponding to the updated slow scan image 405. The image generator 450 computes an image reconstruction loss 420, which is determined as a difference between the predicted slow scan image 415a and a reference image such as the updated slow scan image 405. The image reconstruction loss 420 may be computed as a difference between a pixel value of each pixel of the predicted slow scan image 415a and the updated slow scan image 405. The configuration of the image generator 450 may be updated to reduce the image reconstruction loss 420. For example, updating the image generator 450 includes updating the configurations (e.g., weights, biases, or other parameters) of a neural network based on the image reconstruction loss 420. For example, connection weights may be adjusted to reconcile differences between the neural network's prediction (e.g., predicted slow scan image 415a) and the reference feedback (e.g., updated slow scan image 405). In a further use case, one or more neurons (or nodes) of the neural network may require that their respective errors are sent backward through the neural network to them to facilitate the update process (e.g., backpropagation of error). Updates to the connection weights may, for example, be reflective of the magnitude of error (e.g., loss functions) propagated backward after a forward pass has been completed. In this way, for example, the image generator 450 may be trained to generate better predictions (e.g., SEM images of a substrate).

In an embodiment, training the image generator 450 is an iterative process in which each iteration includes generating a predicted image (e.g., predicted slow scan image 415a), computing a loss function (e.g., image reconstruction loss 420), determining whether the loss function is minimized, updating a configuration of the image generator 450 to reduce the loss function. The iterations may be performed until a specified condition is satisfied (e.g., a predetermined number of iterations, until the loss function is minimized, or another condition). After the training is completed, the image generator 450 is considered to be trained, which may be used to predict a slow scan image for a fast scan image of a defect region of any given substrate.

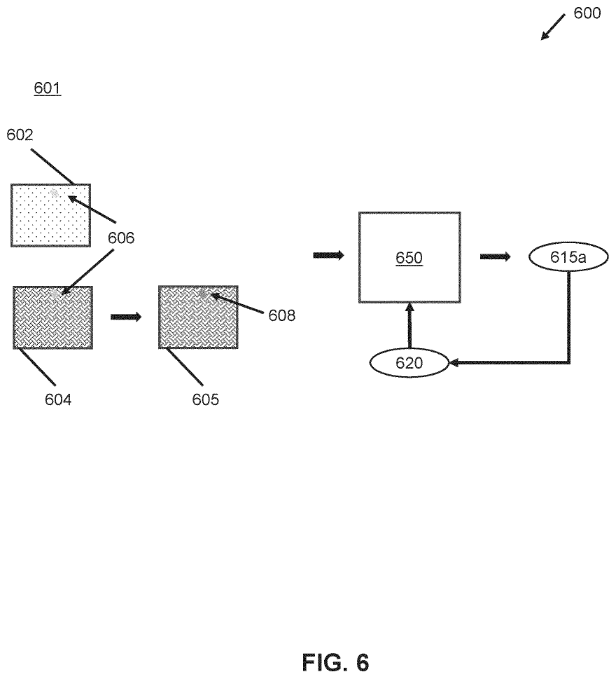

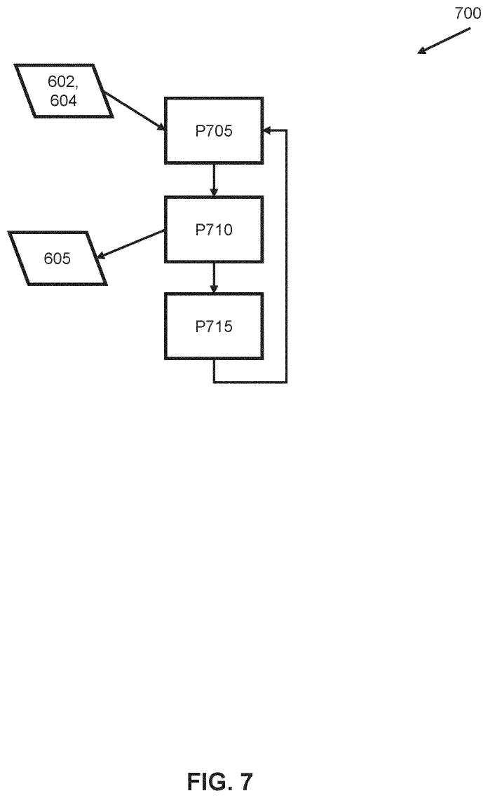

FIG. 6 is a block diagram of an exemplary system 600 for enhancing defects in images for use in training a prediction model to convert a fast scan image to a slow scan image, consistent with various embodiments. FIG. 7 is a flow diagram of an exemplary method 700 for enhancing defects in images for use in training a prediction model to convert a fast scan image to a slow scan image, consistent with various embodiments.

At process P705, an image pair 601 having a fast scan image 602 of an area of a substrate and a corresponding slow scan image 604 of the area of the substrate is obtained. The fast scan image 602 and the slow scan image 604 indicate a defect 606 on the substrate. In an embodiment, the defect signal may be very weak even in the slow scan image 604 and may not be useful in training the prediction model. The prediction model trained using such image may predict a slow scan image that does not indicate the defect at all or may indicate inaccurately.

At process P710, an area of the slow scan image 604 indicating the defect 406 is modified to enhance the defect signal. For example, a contrast of the slow scan image 604 is adjusted (e.g., enhanced) in the area of the defect 606 to improve the defect signal, thus, generating an updated slow scan image 605 indicating a defect 608.

At process P715, an image generator 650 is trained to generate a predicted slow scan image 615a from the fast scan image 602 using the updated slow scan image 605 as a ground truth image or reference image. The image generator 650 may be implemented as a prediction model. The image generator 650 generates a predicted slow scan image 615a corresponding to the updated slow scan image 605. The image generator 650 computes an image reconstruction loss 620, which is determined as a difference between the predicted slow scan image 615a and a reference image such as the updated slow scan image 605. The image reconstruction loss 620 may be computed as a difference between a pixel value of each pixel of the predicted slow scan image 615a and the updated slow scan image 605. In an embodiment, the loss function may include any of the loss functions described below. The configuration of the image generator 650 may be updated to reduce the image reconstruction loss 620. For example, updating the image generator 650 includes updating the configurations (e.g., weights, biases, or other parameters) of a neural network based on the image reconstruction loss 620. For example, connection weights may be adjusted to reconcile differences between the neural network's prediction (e.g., predicted slow scan image 615a) and the reference feedback (e.g., updated slow scan image 605). In a further use case, one or more neurons (or nodes) of the neural network may require that their respective errors are sent backward through the neural network to them to facilitate the update process (e.g., backpropagation of error). Updates to the connection weights may, for example, be reflective of the magnitude of error (e.g., loss functions) propagated backward after a forward pass has been completed. In this way, for example, the image generator 650 may be trained to generate better predictions (e.g., SEM images of a substrate).

In an embodiment, training the image generator 650 is an iterative process in which each iteration includes generating a predicted image (e.g., predicted slow scan image 615a), computing a loss function (e.g., image reconstruction loss 620), determining whether the loss function is minimized, updating a configuration of the image generator 650 to reduce the loss function. The iterations may be performed until a specified condition is satisfied (e.g., a predetermined number of iterations, until the loss function is minimized, or another condition). After the training is completed, the image generator 650 is considered to be trained, which may be used to predict a slow scan image for a fast scan image of a defect region of any given substrate.

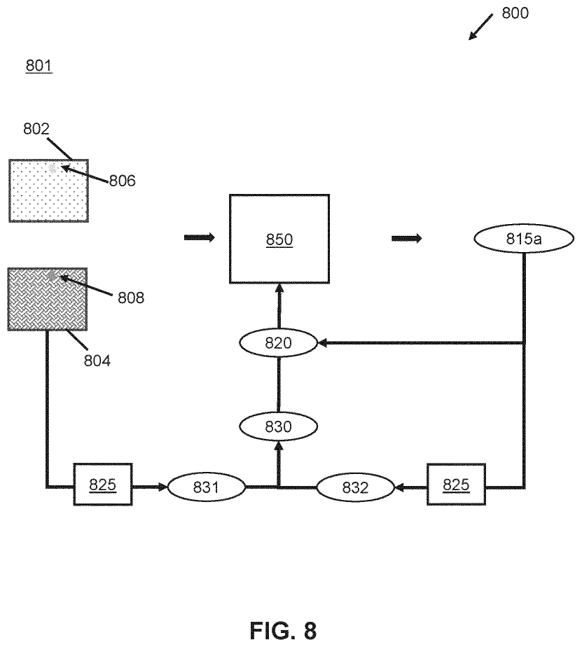

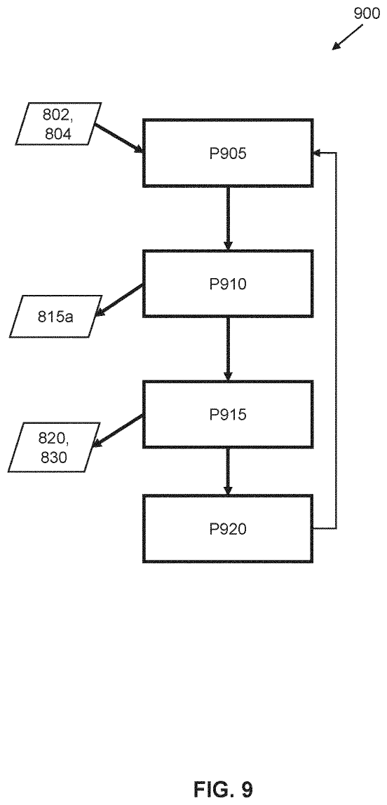

FIG. 8 is a block diagram of an exemplary system 800 for training a prediction model to convert a fast scan image to a slow scan image based on defect distribution in images of a substrate, consistent with various embodiments. FIG. 9 is a flow diagram of an exemplary method 900 for training a prediction model to convert a fast scan image to a slow scan image based on defect distribution in images of a substrate, consistent with various embodiments.

At process P905, an image pair 801 having a fast scan image 802 and a corresponding slow scan image 804 of an area of a substrate is input to an image generator 850. The fast scan image 802 may indicate a defect on the substrate as a defect 806 and the slow scan image 804 as defect 808. The image generator 850 may be implemented as a prediction model.

At process P910, the image generator generates a predicted slow scan image 815a from the fast scan image 802 using the slow scan image 804 as a ground truth image or reference image.

At process P915, the image generator 850 computes a loss function that is indicative of a difference between a defect distribution in the predicted slow scan image 815a and a defect distribution in the reference image such as the slow scan image 804. In an embodiment, the defect distribution in an image is represented using a defect score map, which includes a number of defect scores. Each defect score may be indicative of a probability of presence of a defect in a portion of an image, such as a pixel of an image. A defect score component 1025 may be configured to compute a defect score in various ways. For example, the defect score component 825 may be configured to compare an image of a first die with a reference image of another die (e.g., a die that is known not to have defects) and if there is a difference then the image is considered to include a defect. The defect score component 825 may be configured to assign a score that is indicative of a magnitude of the difference. For example, the defect score component 825 may compare each pixel of an image of the first die with a corresponding pixel at the same location in a reference image of another die (e.g., a second reference image of a second die) and if there is a difference between the pixel values, then a defect may exist in the image at the location of the pixel. The defect score component 825 may further compare the image of the first die with reference images of other dies (e.g., a third image of a third die, a fourth image of a fourth die and so on). The probability that a defect exists in all the reference images is likely low. Accordingly, if there is a similar difference between a pixel of the first image and the corresponding pixel of any of the reference images, the first image likely has a defect at the location of the pixel. The defect score component 825 may determine the defect score for that pixel based on the differences (e.g., by normalizing the differences of multiple comparisons). In an embodiment, the defect score component 825 may also consider the differences associated with one or more neighboring pixels of a pixel (e.g., difference between a neighboring pixel of a pixel in the first image and the corresponding pixel in the reference image in the same location as the neighboring pixel) in determining the defect score for the pixel. For example, the defect score component 825 may aggregate the differences associated with the neighboring pixel with the differences associated with the pixel in determining a defect score of the pixel. In an embodiment, a portion of the image (e.g., a pixel) having a defect score above a specified threshold may be considered as indicative of a defect.

The predicted slow scan image 815a may be input to the defect score component 825, which generates a predicted defect score map 832 having defect scores that are indicative of a probability of presence of a defect in the predicted slow scan image 815a. Similarly, the defect score component 825 may generate a reference defect score map 831 that is indicative of a probability of presence of a defect in the slow scan image 804. The image generator 850 computes a defect-based loss 830 as a difference between the defect scores between the two images. For example, the defect-based loss may be represented as:

$${loss}_{defect} = dsm\_weight * {\vert dsm\_pred - dsm\_gt \vert}^{x} \qquad Eq . ( 1 )$$

where dsm_weight is a weight associated with the defect distribution, dsm_pred is a defect score associated with the predicted slow scan image 815a and dsm_gt is a defect score associated with the slow scan image 804, and “x” is the order or degree (e.g., 2).

In an embodiment, computing the loss function may further include computing an image reconstruction loss 820, which is determined as a difference between the predicted slow scan image 815a and the slow scan image 804. The image reconstruction loss 820 may be computed as a difference between a pixel value of each pixel of the predicted slow scan image 815a and the slow scan image 1004. For example, the image reconstruction loss 820 may be represented as:

$${loss}_{reconstruction} = {\vert img\_pred - img\_gt \vert}^{x} \qquad Eq . ( 2 )$$

where img_pred is a pixel value associated with the predicted slow scan image 815a and img_gt is a pixel value associated with the slow scan image 804, and “x” is the order or degree (e.g., 2).

The image generator 850 may compute the loss function as a function of both the defect-based loss 830 and the image reconstruction loss 820, which may be represented as:

$$Loss = {loss}_{reconstruction} + {loss}_{defect} \qquad Eq . ( 3 )$$

At process P920, the image generator 850 may be modified based on the loss function (e.g., Eq. (3)). For example, a configuration of the image generator 850 may be updated to reduce the loss function (e.g., Eq. (3)). In an embodiment, updating the image generator 850 includes updating the configurations (e.g., weights, biases, or other parameters) of a neural network based on the loss function. For example, connection weights may be adjusted to reconcile differences between the neural network's prediction (e.g., predicted slow scan image 815a) and the reference feedback (e.g., slow scan image 804). In a further use case, one or more neurons (or nodes) of the neural network may require that their respective errors are sent backward through the neural network to them to facilitate the update process (e.g., backpropagation of error). Updates to the connection weights may, for example, be reflective of the magnitude of error (e.g., loss functions) propagated backward after a forward pass has been completed. In this way, for example, the image generator 850 may be trained to generate better predictions (e.g., SEM images of a substrate).

In an embodiment, training the image generator 850 is an iterative process in which each iteration includes generating a predicted image (e.g., predicted slow scan image 815a), computing a loss function (e.g., Eq. (3)), determining whether the loss function is minimized, updating a configuration of the image generator 850 to reduce the loss function. The iterations may be performed until a specified condition is satisfied (e.g., a predetermined number of iterations, until the loss function is minimized, or another condition). After the training is completed, the image generator 850 is considered to be trained, which may be used to predict a slow scan image for a fast scan image of a defect region of any given substrate.

In an embodiment, by training the image generator 850 based on the defect distribution (e.g., defect score maps), the image generator 850 is trained to predict an image with similar defect score map as a ground truth image, which minimizes errors such as predicting areas that are not defects as defects or missing any areas with defects, thereby improving a capture rate of the defects.

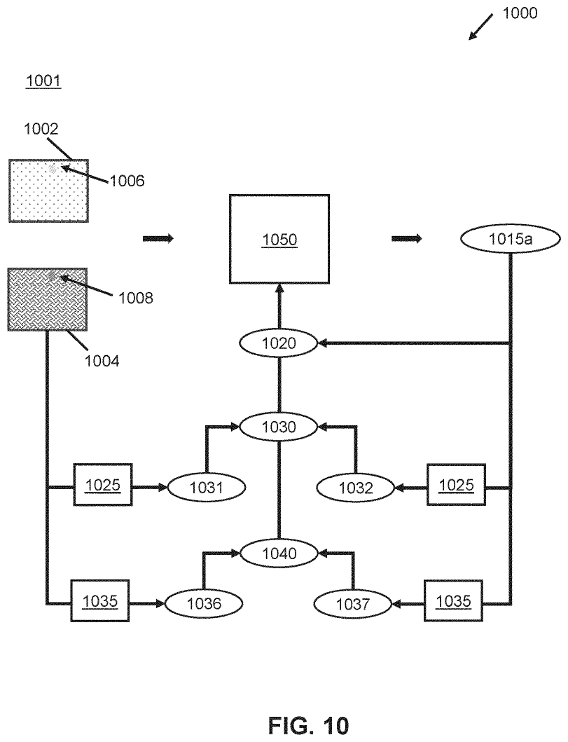

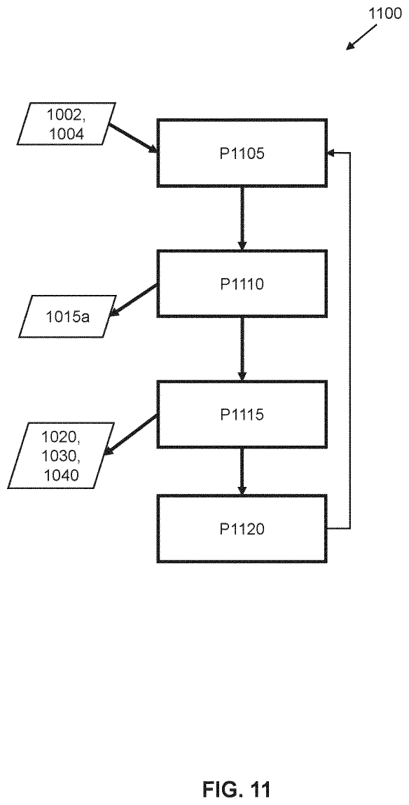

FIG. 10 is a block diagram of an exemplary system 1000 for training a prediction model to convert a fast scan image to a slow scan image based on classifier feature maps associated with images of a substrate, consistent with various embodiments. FIG. 11 is a flow diagram of an exemplary method 1100 for training a prediction model to convert a fast scan image to a slow scan image based on classifier feature maps associated with images of a substrate, consistent with various embodiments.

At process P1105, an image pair 1001 having a fast scan image 1002 and a corresponding slow scan image 1004 of an area of a substrate is input to an image generator 1050. The fast scan image 1002 may indicate a defect on the substrate as a defect 1006 and the slow scan image 1004 as defect 1008. The image generator 1050 may be implemented as a prediction model.

At process P1110, the image generator generates a predicted slow scan image 1015a from the fast scan image 1002 using the slow scan image 1004 as a ground truth image or reference image.

At process P1115, the image generator 1050 computes a loss function that is indicative of a difference between a first set of characterization feature vectors associated with the predicted slow scan image 1015a and a second set of characterization feature vectors associated with the reference image such as the slow scan image 1004. In an embodiment, a characterization feature vector represents characteristics of an image. For example, the characterization feature vectors may be used to represent characteristics of a defect and a nuisance (e.g., false defect) in an image. A characterization feature vector includes a set of numbers (e.g., pixel values) that represents a characteristic of a pixel, which may be generated using a feature extraction filter (e.g., wavelet filter, low-pass image filter, etc.). For example, when a low-pass image filter is applied to an image, a characterization feature vector that indicates low frequency characteristics of the pixels is generated, and when a wavelet filter is applied to the image a characterization feature vector that indicates high frequency characteristics of the pixels is generated. A classifier feature map, which is an image, may be generated based on the pixel values in the characterization feature vectors. Different classifier feature maps may be generated using different characterization feature extraction filters, and each classifier feature map is indicative of a particular characteristic of an image.

The predicted slow scan image 1015a may be input to a characterization feature vector generation component 1035, which generates a predicted classifier feature map 1037 having a first set of characterization feature vectors associated with the predicted slow scan image 1015a. Similarly, the characterization feature vector generation component 1035 may generate a reference classifier feature map 1036 having a second set of characterization feature vectors associated with the slow scan image 1004. The characterization feature vector generation component 1035 may be configured to generate a number of classifier feature maps (CFM) for each of the images by applying various feature extraction filters. The image generator 1050 computes a CFM-based loss 1040 as a difference between the characterization feature vectors of the two images. For example, the CFM-based loss may be represented as:

$${loss}_{CFM} = CFM\_weight * sum ( {w}_{i} * {\vert {CFM}_{{i}_{pred}} - {CFM}_{{i}_{gt}} \vert}^{x} ) \qquad Eq . ( 4 )$$

where CFM_weight is a weight associated with the CFM component of the loss function, wᵢ is the weight of i^{th} CFM, CFM_pred is a CFM associated with the predicted slow scan image 1015a and CFM_gt is a CFM associated with the slow scan image 1004, and “x” is the order or degree (e.g., 2).

The image generator 1050 may also compute a defect-based loss 1030 associated with the images. For example, a defect-based loss 1030 may be computed as a difference between the defect scores between the two images using defect score maps 1031 and 1032 generated using a defect score component 1025 (e.g., similar to the defect score component 825 of FIG. 8), as described at least with reference to FIGS. 8 and 9 above.

In an embodiment, computing the loss function may further include computing an image reconstruction loss 1020, which is determined as a pixel-to-pixel difference between the predicted slow scan image 1015a and the slow scan image 1004 (e.g., as described at least with reference to FIGS. 8 and 9).

The image generator 1050 may compute the loss function as a function of one or more of the CFM-based loss 1040, the defect-based loss 1030 or the image reconstruction loss 1020, which may be represented as:

$$Loss = {loss}_{reconstruction} + {loss}_{defect} + {loss}_{CFM} \qquad Eq . ( 5 )$$

At process P1120, the image generator 1050 may be modified based on the loss function (e.g., Eq. (5)). For example, a configuration of the image generator 1050 may be updated to reduce the loss function. In an embodiment, updating the image generator 1050 includes updating the configurations (e.g., weights, biases, or other parameters) of a neural network based on the loss function. For example, connection weights may be adjusted to reconcile differences between the neural network's prediction (e.g., predicted slow scan image 1015a) and the reference feedback (e.g., slow scan image 1004). In a further use case, one or more neurons (or nodes) of the neural network may require that their respective errors are sent backward through the neural network to them to facilitate the update process (e.g., backpropagation of error). Updates to the connection weights may, for example, be reflective of the magnitude of error (e.g., loss functions) propagated backward after a forward pass has been completed. In this way, for example, the image generator 1050 may be trained to generate better predictions (e.g., SEM images of a substrate).

In an embodiment, training the image generator 1050 is an iterative process in which each iteration includes generating a predicted image (e.g., predicted slow scan image 1015a), computing a loss function (e.g., Eq. (5)), determining whether the loss function is minimized, updating a configuration of the image generator 1050 to reduce the loss function. The iterations may be performed until a specified condition is satisfied (e.g., a predetermined number of iterations, until the loss function is minimized, or another condition). After the training is completed, the image generator 1050 is considered to be trained, which may be used to predict a slow scan image for a fast scan image of a defect region of any given substrate.

In an embodiment, by training the image generator 1050 based on the CFM, the image generator 1050 is trained to predict an image with similar classifier feature map as a ground truth image which minimizes errors such as predicting defects as nuisance or vice versa, thereby improving a capture rate of the defects.

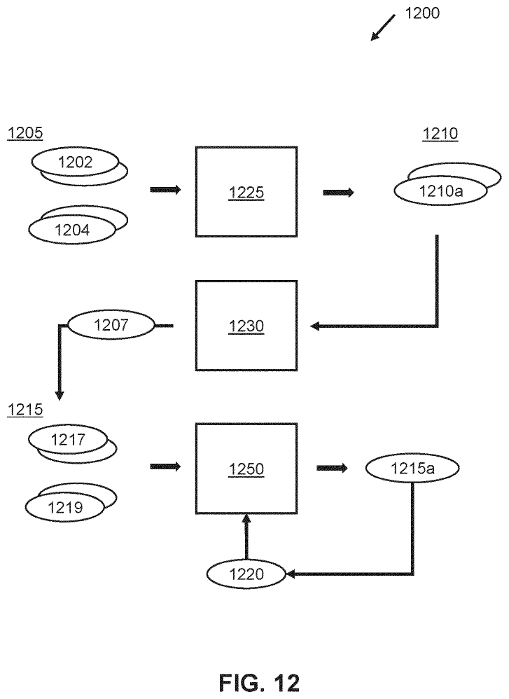

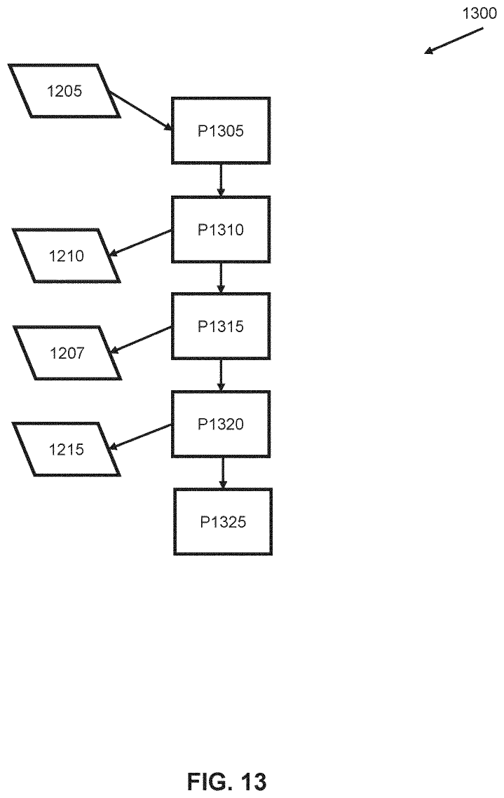

FIG. 12 is a block diagram of an exemplary system 1200 for selecting images for use in training a prediction model to convert a fast scan image to a slow scan image, consistent with various embodiments. FIG. 13 is a flow diagram of an exemplary method 1300 for selecting images for use in training a prediction model to convert a fast scan image to a slow scan image, consistent with various embodiments.

At process P1305, a set of image pairs 1205 in which an image pair includes a fast scan image 1202 and a corresponding slow scan image 1204 of an area of the substrate is obtained. The fast scan image 1202 and the slow scan image 1204 may or may not indicate any defects on the substrate. In the example of FIG. 12, at least some of the image pairs 1205 indicate one or more defects on the substrate.

At process P1310, the image pairs 1205 are input to a defect score component 1225 to generate defect score maps 1210 for slow scan images in the image pairs 1205. For example, the defect score component 1225 generates a defect score map 1210a for a slow scan image 1204 in a first image pair of the image pairs 1205. As described above, a defect score map includes a number of defect scores (e.g., one score per pixel of the image) and a defect score is indicative of a probability of presence of a defect in the corresponding pixel. Any portion of the image having a defect score above a specified threshold may be identified as a defect candidate. A defect candidate may be a golden defect (e.g., an actual defect) or a nuisance (e.g., false defect).

At process P1315, the defect score maps 1210 may be input to an image selector 1230 that is configured to identify those of the defect score maps 1210 having defect scores in a target range. As described above, a defect candidate having a defect score below a first threshold score or above a second threshold score may be easily categorized into a nuisance or defect, respectively. However, defect detection probability, that is, differentiating golden defects from nuisance, for defect candidates having defect scores in a “target” range that lies between the first threshold score and the second threshold score is very low. Accordingly, the image selector 1230 is configured to identify a subset of the defect score maps 1210, e.g., defect score maps 1207, having defect scores in the target range. For example, the image selector 1230 may select those of the defect score maps 1210 in which defect candidates categorized as a golden defect or nuisance are associated with a defect score that is in the target range. The image selector 1230 further identifies the slow scan images associated with the defect score maps 1207.

At process P1320, the image selector 1230 may select a subset of the image pairs 1205, e.g., image pairs 1215, having slow scan images associated with the defect score maps 1207 (e.g., selected in process P1315).

At process P1325, the selected image pairs 1215 are input to an image generator 1250 train the image generator 1250 to generate a predicted slow scan image from a fast scan image. The image generator 1250 may be implemented as a prediction model. For example, the image generator 1250 may generate a predicted slow scan image 1215a from a fast scan image 1217 using the corresponding slow scan image 1219 as a ground truth image or reference image. The image generator 1250 generates a predicted slow scan image 1215a corresponding to the slow scan image 1219. The image generator 1250 computes an image reconstruction loss 1220, which is determined as a difference between the predicted slow scan image 1215a and a reference image such as the slow scan image 1219. The image reconstruction loss 1220 may be computed as a difference between a pixel value of each pixel of the predicted slow scan image 1215a and the slow scan image 1219. The configuration of the image generator 1250 may be updated to reduce the image reconstruction loss 1220. For example, updating the image generator 1250 includes updating the configurations (e.g., weights, biases, or other parameters) of a neural network based on the image reconstruction loss 1220. For example, connection weights may be adjusted to reconcile differences between the neural network's prediction (e.g., predicted slow scan image 1215a) and the reference feedback (e.g., slow scan image 1219). In a further use case, one or more neurons (or nodes) of the neural network may require that their respective errors are sent backward through the neural network to them to facilitate the update process (e.g., backpropagation of error). Updates to the connection weights may, for example, be reflective of the magnitude of error (e.g., loss functions) propagated backward after a forward pass has been completed. In this way, for example, the image generator 1250 may be trained to generate better predictions (e.g., SEM images of a substrate).

In an embodiment, training the image generator 1250 is an iterative process in which each iteration includes generating a predicted image (e.g., predicted slow scan image 1215a), computing a loss function (e.g., image reconstruction loss 1220), determining whether the loss function is minimized, updating a configuration of the image generator 1250 to reduce the loss function. The iterations may be performed until a specified condition is satisfied (e.g., a predetermined number of iterations, until the loss function is minimized, or another condition). After the training is completed, the image generator 1250 is considered to be trained, which may be used to predict a slow scan image for a fast scan image of a defect region of any given substrate.

In an embodiment, by selecting those of the image pairs having defect scores in the target range and training a prediction model with the selected image pairs enables the prediction model or improves an accuracy of the prediction model in differentiating a defect from nuisance (e.g., including for those defect candidates having scores in the target range) thereby converting a fast scan image to a slow scan image with an improved defect capture rate.

Note that the image pair 801 used to train the image generator 850 or the image pair 1001 used to train the image generator 1050 may be obtained by at least one of (a) adding defects to a fast scan image and a corresponding slow scan image, as described at least with reference to FIGS. 4 and 5, (b) modifying a portion of a slow scan image, e.g., enhancing a contrast of the defect region, as described at least with reference to FIGS. 6 and 7, or (c) selecting the image pair from a number of image pairs based on defect detection probability, as described at least with reference to FIGS. 12 and 13.

In an embodiment, any of the above trained image generators may be used to predict a slow scan image from a fast scan image indicative of a defect on any given substrate. For example, a slow scan image of a defect region on a substrate or any other LR image of a defect region on a substrate may be input to a trained image generator. The image generator is executed to predict a slow scan image or a HR image (e.g., image resolution greater than that of the input image) of the defect region on the substrate.

The predicted slow scan image may be used for various purposes. For example, after inspecting the defects in the predicted slow scan image, the patterning process or a lithographic apparatus may be optimized or adjusted (e.g., one or more parameters of a patterning process or a lithographic apparatus) to minimize the defects in patterning a target layout on the substrate. The optimized patterning process is then performed to print patterns corresponding to the target layout on the substrate.

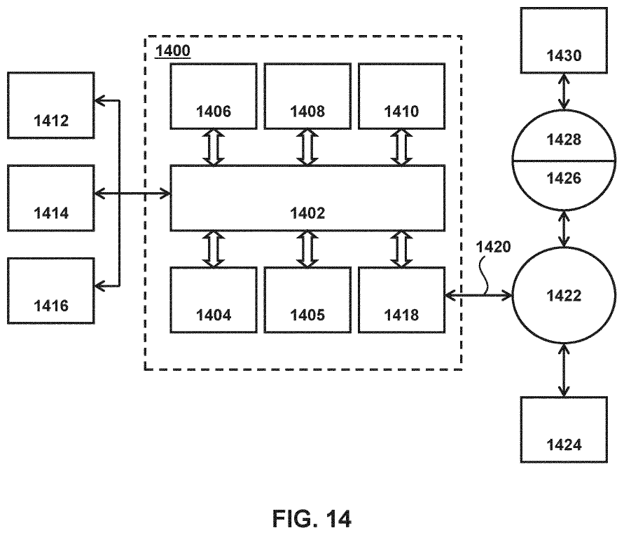

FIG. 14 is a block diagram that illustrates a computer system 1400 which can assist in implementing in various methods and systems disclosed herein. The computer system 1400 may be used to implement any of the entities, components, modules, or services depicted in the examples of the figures (and any other entities, components, modules, or services described in this specification). The computer system 1400 may be programmed to execute computer program instructions to perform functions, methods, flows, or services (e.g., of any of the entities, components, or modules) described herein. The computer system 1400 may be programmed to execute computer program instructions by at least one of software, hardware, or firmware.

Computer system 1400 includes a bus 1402 or other communication mechanism for communicating information, and a processor 1404 (or multiple processors 1404 and 1405) coupled with bus 1402 for processing information. Computer system 1400 also includes a main memory 1406, such as a random-access memory (RAM) or other dynamic storage device, coupled to bus 1402 for storing information and instructions to be executed by processor 1404. Main memory 1406 also may be used for storing temporary variables or other intermediate information during execution of instructions to be executed by processor 1404. Computer system 1400 further includes a read only memory (ROM) 1408 or other static storage device coupled to bus 1402 for storing static information and instructions for processor 1404. A storage device 1410, such as a magnetic disk or optical disk, is provided and coupled to bus 1402 for storing information and instructions.

Computer system 1400 may be coupled via bus 1402 to a display 1412, such as a cathode ray tube (CRT) or flat panel or touch panel display for displaying information to a computer user. An input device 1414, including alphanumeric and other keys, is coupled to bus 1402 for communicating information and command selections to processor 1404. Another type of user input device is cursor control 1416, such as a mouse, a trackball, or cursor direction keys for communicating direction information and command selections to processor 1404 and for controlling cursor movement on display 1412. This input device typically has two degrees of freedom in two axes, a first axis (e.g., x) and a second axis (e.g., y), that allows the device to specify positions in a plane. A touch panel (screen) display may also be used as an input device.

According to one embodiment, portions of one or more methods described herein may be performed by computer system 1400 in response to processor 1404 executing one or more sequences of one or more instructions contained in main memory 1406. Such instructions may be read into main memory 1406 from another computer-readable medium, such as storage device 1410. Execution of the sequences of instructions contained in main memory 1406 causes processor 1404 to perform the process steps described herein. One or more processors in a multi-processing arrangement may also be employed to execute the sequences of instructions contained in main memory 1406. In an alternative embodiment, hard-wired circuitry may be used in place of or in combination with software instructions. Thus, the description herein is not limited to any specific combination of hardware circuitry and software.

The term “computer-readable medium” as used herein refers to any medium that participates in providing instructions to processor 1404 for execution. Such a medium may take many forms, including but not limited to, non-volatile media, volatile media, and transmission media. Non-volatile media include, for example, optical or magnetic disks, such as storage device 1410. Volatile media include dynamic memory, such as main memory 1406. Transmission media include coaxial cables, copper wire and fiber optics, including the wires that comprise bus 1402. Transmission media can also take the form of acoustic or light waves, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 1404 for execution. For example, the instructions may initially be borne on a magnetic disk of a remote computer. The remote computer can load the instructions into its dynamic memory and send the instructions over a telephone line using a modem. A modem local to computer system 1400 can receive the data on the telephone line and use an infrared transmitter to convert the data to an infrared signal. An infrared detector coupled to bus 1402 can receive the data carried in the infrared signal and place the data on bus 1402. Bus 1402 carries the data to main memory 1406, from which processor 1404 retrieves and executes the instructions. The instructions received by main memory 1406 may optionally be stored on storage device 1410 either before or after execution by processor 1404.

Computer system 1400 also preferably includes a communication interface 1418 coupled to bus 1402. Communication interface 1418 provides a two-way data communication coupling to a network link 1420 that is connected to a local network 1422. For example, communication interface 1418 may be an integrated services digital network (ISDN) card or a modem to provide a data communication connection to a corresponding type of telephone line. As another example, communication interface 1418 may be a local area network (LAN) card to provide a data communication connection to a compatible LAN. Wireless links may also be implemented. In any such implementation, communication interface 1418 sends and receives electrical, electromagnetic, or optical signals that carry digital data streams representing various types of information.

Network link 1420 typically provides data communication through one or more networks to other data devices. For example, network link 1420 may provide a connection through local network 1422 to a host computer 1424 or to data equipment operated by an Internet Service Provider (ISP) 1426. ISP 1426 in turn provides data communication services through the worldwide packet data communication network, now commonly referred to as the “Internet” 1428. Local network 1422 and Internet 1428 both use electrical, electromagnetic, or optical signals that carry digital data streams. The signals through the various networks and the signals on network link 1420 and through communication interface 1418, which carry the digital data to and from computer system 1400, are exemplary forms of carrier waves transporting the information.

Computer system 1400 can send messages and receive data, including program code, through the network(s), network link 1420, and communication interface 1418. In the Internet example, a server 1430 might transmit a requested code for an application program through Internet 1428, ISP 1426, local network 1422 and communication interface 1418. One such downloaded application may provide for the illumination optimization of an embodiment, for example. The received code may be executed by processor 1404 as it is received, or stored in storage device 1410, or other non-volatile storage for later execution. In this manner, computer system 1400 may obtain application code in the form of a carrier wave.

While the concepts disclosed herein may be used for imaging on a substrate such as a silicon wafer, it shall be understood that the disclosed concepts may be used with any type of lithographic imaging systems, e.g., those used for imaging on substrates other than silicon wafers.

The terms “optimizing” and “optimization” as used herein refers to or means adjusting a patterning apparatus (e.g., a lithography apparatus), a patterning process, etc. such that results and/or processes have more desirable characteristics, such as higher accuracy of projection of a design pattern on a substrate, a larger process window, etc. Thus, the term “optimizing” and “optimization” as used herein refers to or means a process that identifies one or more values for one or more parameters that provide an improvement, e.g., a local optimum, in at least one relevant metric, compared to an initial set of one or more values for those one or more parameters. “Optimum” and other related terms should be construed accordingly. In an embodiment, optimization steps can be applied iteratively to provide further improvements in one or more metrics.

Aspects of the invention can be implemented in any convenient form. For example, an embodiment may be implemented by one or more appropriate computer programs which may be carried on an appropriate carrier medium which may be a tangible carrier medium (e.g., a disk) or an intangible carrier medium (e.g., a communications signal). Embodiments of the invention may be implemented using suitable apparatus which may specifically take the form of a programmable computer running a computer program arranged to implement a method as described herein. Thus, embodiments of the disclosure may be implemented in hardware, firmware, software, or any combination thereof. Embodiments of the disclosure may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical, or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g., within a data center or geographically), or otherwise differently organized. The functionality described herein may be provided by one or more processors of one or more computers executing code stored on a tangible, non-transitory, machine-readable medium. In some cases, third party content delivery networks may host some or all of the information conveyed over networks, in which case, to the extent information (e.g., content) is said to be supplied or otherwise provided, the information may be provided by sending instructions to retrieve that information from a content delivery network.

Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device.

The reader should appreciate that the present application describes several inventions. Rather than separating those inventions into multiple isolated patent applications, these inventions have been grouped into a single document because their related subject matter lends itself to economies in the application process. But the distinct advantages and aspects of such inventions should not be conflated. In some cases, embodiments address all of the deficiencies noted herein, but it should be understood that the inventions are independently useful, and some embodiments address only a subset of such problems or offer other, unmentioned benefits that will be apparent to those of skill in the art reviewing the present disclosure. Due to costs constraints, some inventions disclosed herein may not be presently claimed and may be claimed in later filings, such as continuation applications or by amending the present claims. Similarly, due to space constraints, neither the Abstract nor the Summary sections of the present document should be taken as containing a comprehensive listing of all such inventions or all aspects of such inventions.

It should be understood that the description and the drawings are not intended to limit the present disclosure to the particular form disclosed, but to the contrary, the intention is to cover all modifications, equivalents, and alternatives falling within the spirit and scope of the inventions as defined by the appended claims.

Modifications and alternative embodiments of various aspects of the inventions will be apparent to those skilled in the art in view of this description. Accordingly, this description and the drawings are to be construed as illustrative only and are for the purpose of teaching those skilled in the art the general manner of carrying out the inventions. It is to be understood that the forms of the inventions shown and described herein are to be taken as examples of embodiments. Elements and materials may be substituted for those illustrated and described herein, parts and processes may be reversed or omitted, certain features may be utilized independently, and embodiments or features of embodiments may be combined, all as would be apparent to one skilled in the art after having the benefit of this description. Changes may be made in the elements described herein without departing from the spirit and scope of the invention as described in the following claims. Headings used herein are for organizational purposes only and are not meant to be used to limit the scope of the description.

As used herein, unless specifically stated otherwise, the term “or” encompasses all possible combinations, except where infeasible. For example, if it is stated that a component includes A or B, then, unless specifically stated otherwise or infeasible, the component may include A, or B, or A and B. As a second example, if it is stated that a component includes A, B, or C, then, unless specifically stated otherwise or infeasible, the component may include A, or B, or C, or A and B, or A and C, or B and C, or A and B and C. Expressions such as “at least one of” do not necessarily modify an entirety of a following list and do not necessarily modify each member of the list, such that “at least one of A, B, and C” should be understood as including only one of A, only one of B, only one of C, or any combination of A, B, and C. The phrase “one of A and B” or “any one of A and B” shall be interpreted in the broadest sense to include one of A, or one of B.

Embodiments are provided according to the following clauses:
1. A non-transitory computer-readable medium having instructions that, when executed by a computer system, cause the computer system to at least execute a method for training a machine learning model to generate an image representing defects on a substrate, the method comprising:
   inputting a first image and a reference image representative of images captured using different image capture conditions to a neural network, the first image and the reference image indicate defects on a substrate patterned with a target layout;
   generating, using the neural network, a predicted image in response to the first image;
   computing a loss function that is indicative of a difference between a defect distribution in the predicted image and a defect distribution in the reference image; and
   modifying the neural network based on the loss function.
2. The computer-readable medium of clause 1, wherein computing the loss function includes:
   determining the defect distribution in the predicted image as a predicted defect score map in which a defect score is indicative of a probability of presence of a defect in a portion of the predicted image;
   determining the defect distribution in the reference image as a reference defect score map in which a defect score is indicative of a probability of presence of a defect in a portion of the reference image; and
   computing the difference between the predicted defect score map and the reference defect score map.
3. The computer-readable medium of clause 2, wherein the defect score satisfying a threshold score is representative of a defect on the substrate in a location corresponding to the portion of the reference image.
4. The computer-readable medium of any of clauses 1-3, wherein computing the loss function further includes computing a difference between a first set of feature vectors of the predicted image and a second set of feature vectors of the reference image.
5. The computer-readable medium of clause 4, wherein computing the difference includes:
   applying a feature extraction filter to the reference image to obtain the first set of feature vectors as a reference classifier feature map, which is representative of features of a defect or nuisance in the reference image;
   applying the feature extraction filter to the predicted image to obtain the second set of feature vectors as a predicted classifier feature map, which is representative of features of a defect or nuisance in the predicted image; and
   computing a difference between the reference classifier feature map and the predicted classifier feature map.
6. The computer-readable medium of clause 1, wherein computing the loss function further includes computing a pixel-to-pixel difference between the predicted image and the reference image.
7. The computer-readable medium of clause 1, wherein modifying the neural network based on the loss function includes modifying parameters of the neural network until the loss function is minimized.
8. The computer-readable medium of clause 1, wherein the first image corresponds to a fast scan image capture condition, and the predicted image and the reference image correspond to a slow scan image capture condition.
9. The computer-readable medium of clause 8, wherein the first image is of a lower resolution than the reference image.
10. The computer-readable medium of clause 1, wherein inputting the first image and the reference image includes adding a defect to the first image and the reference image.
11. The computer-readable medium of clause 10, wherein adding the defect to the first image and the reference image includes editing a portion of the first image and the reference image to match with a portion of a specified image that is indicative of a defect on the substrate.
12. The computer-readable medium of clause 1, wherein inputting the first image and the reference image includes selecting a first image pair of multiple image pairs based on defect detection probability of reference images in the image pairs, wherein the first image pair includes the first image and the reference image.
13. The computer-readable medium of clause 12, wherein selecting the first image pair includes selecting those of the image pairs in which a reference image is associated with a defect score map having a defect score of a defect and a nuisance within a first range.
14. The computer-readable medium of clause 1 further comprising:
   inputting a specified image of a specified substrate captured in a fast scan image capture condition to the neural network; and
   executing the neural network to generate a specified predicted image based on the specified image, the specified predicted image representative of defects on the specified substrate and corresponding to a slow scan image capture condition.
15. The computer-readable medium of clause 14 further comprising adjusting a parameter of at least one of a patterning process or a lithographic apparatus based on the specified predicted image to minimize the defects in patterning a target layout on the specified substrate.
16. The computer-readable medium of clause 15 further comprising performing the patterning process via the lithographic apparatus to print patterns corresponding to the target layout on the substrate.
17. A non-transitory computer-readable medium having instructions that, when executed by a computer, cause the computer to execute a method for training a machine learning model to generate an image representing defects on a substrate, the method comprising:
   inputting a first image and a reference image representative of images captured using different image capture conditions to a neural network, the first image and the reference image representative of defects on a substrate patterned with a target layout;
   generating, using the neural network, a predicted image in response to the first image;
   computing a loss function that is indicative of a difference between a first set of feature vectors of the predicted image and a second set of feature vectors of the reference image; and
   modifying the neural network based on the loss function.
18. The computer-readable medium of clause 17, wherein computing the loss function includes:
   applying a feature extraction filter to the reference image to obtain the first set of feature vectors as a reference classifier feature map, which is representative of features of a defect or nuisance in the reference image;
   applying a feature extraction filter to the predicted image to obtain the second set of feature vectors as a predicted classifier feature map, which is representative of features of a defect or nuisance in the predicted image; and
   computing the difference between the predicted classifier feature map and the reference classifier feature map.
19. The computer-readable medium of clause 17, wherein computing the loss function further includes computing a difference between a defect distribution in the predicted image and a defect distribution in the reference image.
20. The computer-readable medium of clause 19, wherein computing the difference includes:
   determining the defect distribution in the predicted image as a predicted defect score map in which a defect score is indicative of a probability of presence of a defect in a portion of the predicted image;
   determining the defect distribution in the reference image as a reference defect score map in which a defect score is indicative of a probability of presence of a defect in a portion of the reference image; and
   computing the difference between the predicted defect score map and the reference defect score map.
21. The computer-readable medium of clause 20, wherein the defect score satisfying a threshold score is representative of a defect on the substrate in a location corresponding to the portion of the reference image.
22. The computer-readable medium of clause 17, wherein computing the loss function further includes computing a pixel-to-pixel difference between the predicted image and the reference image.
23. The computer-readable medium of clause 17, wherein modifying the neural network based on the loss function includes modifying parameters of the neural network until the loss function is minimized.
24. The computer-readable medium of clause 17, wherein the first image corresponds to a first image capture condition, and the reference image and the predicted image correspond to a second image capture condition.
25. The computer-readable medium of clause 24, wherein the first image is of a lower resolution than the reference image.
26. The computer-readable medium of clause 17, wherein inputting the first image and the reference image includes adding a defect to the first image and the reference image.
27. The computer-readable medium of clause 26, wherein adding the defect to the first image and the reference image includes editing a portion of the first image and the reference image to match with a portion of a specified image that is indicative of a defect on the substrate.
28. The computer-readable medium of clause 17, wherein inputting the first image and the reference image includes selecting a first image pair of multiple image pairs based on defect detection probability of reference images in the image pairs, wherein the first image pair includes the first image and the reference image.
29. The computer-readable medium of clause 28, wherein selecting the first image pair includes:
   selecting those of the image pairs in which a reference image is associated with a defect score map having a defect score of a defect and a nuisance within a first range.
30. The computer-readable medium of clause 17 further comprising:
   inputting a specified image of a specified substrate captured in a fast scan image capture condition to the neural network; and
   executing the neural network to generate a specified predicted image based on the specified image, the specified predicted image representative of defects on the specified substrate and corresponding to a slow scan image capture condition.
31. A non-transitory computer-readable medium having instructions that, when executed by a computer, cause the computer to execute a method for training a machine learning model to generate an image indicative of defects on a substrate, the method comprising:
   obtaining a first image and a reference image captured using different image capture conditions, the first image and the reference image representative of defects on a substrate patterned with a target layout;
   adding a defect to the first image and the reference image to generate an updated first image and an updated reference image; and
   training a neural network with the updated first image and the updated reference image to convert the updated first image to a predicted image using the updated reference image, wherein the predicted image is representative of defects on the substrate and corresponds to an image capture condition of the reference image.
32. The computer-readable medium of clause 31, wherein adding the defect to an image includes editing a portion of the image to match with a portion of the reference image or the first image that is indicative of a defect on the substrate.
33. The computer-readable medium of clause 31, wherein training the neural network is an iterative process and each iteration includes:
   determining a difference between the predicted image the updated reference image;
   determining whether the difference is reduced; and
   responsive to a determination that the difference is not reduced, modifying parameters of the neural network and repeating an iteration.
34. The computer-readable medium of clause 31, wherein the first image corresponds to a first image capture condition, and the reference image corresponds to a second image capture condition.
35. The computer-readable medium of clause 34, wherein the first image is of a lower resolution than the reference image.
36. The computer-readable medium of clause 31 further comprising:
   inputting a specified image of a specified substrate captured in a fast scan image capture condition to the neural network; and
   executing the neural network to generate a specified predicted image based on the specified image, the specified predicted image representative of defects on the specified substrate and corresponding to a slow scan image capture condition.
37. A non-transitory computer-readable medium having instructions that, when executed by a computer, cause the computer to execute a method for training a machine learning model to generate an image indicative of defects on a substrate, the method comprising:
   obtaining a first image and a reference image captured using different image capture conditions, the first image and the reference image representative of defects on a substrate patterned with a target layout;
   modifying an area of the reference image that is representative of a defect to generate an updated reference image; and
   training a neural network to convert the first image to a predicted image using the updated reference image, wherein the predicted image is representative of defects on the substrate and corresponds to an image capture condition of the reference image.
38. The computer-readable medium of clause 37, wherein modifying the area of the reference image includes enhancing a contrast of the area of the reference image.
39. The computer-readable medium of clause 37, wherein training the neural network is an iterative process and each iteration includes:
   determining a difference between the predicted image the updated reference image;
   determining whether the difference is reduced; and
   responsive to a determination that the difference is not reduced, modifying parameters of the neural network and repeating an iteration.
40. The computer-readable medium of clause 37, wherein the first image corresponds to a first image capture condition, and the reference image corresponds to a second image capture condition.
41. The computer-readable medium of clause 40, wherein the first image is of a lower resolution than the reference image.
42. The computer-readable medium of clause 37 further comprising:
   inputting a specified image of a specified substrate captured in a fast scan image capture condition to the neural network; and
   executing the neural network to generate a specified predicted image based on the specified image, the specified predicted image representative of defects on the specified substrate and corresponding to a slow scan image capture condition.
43. A non-transitory computer-readable medium having instructions that, when executed by a computer, cause the computer to execute a method for training a machine learning model to generate an image indicative of defects on a substrate, the method comprising:
   obtaining multiple image pairs, wherein each image pair includes a first image and a reference image captured using different image capture conditions, the first image and the reference image representative of defects on a substrate patterned with a target layout;
   determining a defect detection probability of reference images of the image pairs;
   selecting a subset of the image pairs based on the defect detection probability; and
   training a neural network with subset of image pairs to convert the first image of an image pair of the subset of image pairs to a predicted image using the reference image of the image pair, wherein the predicted image is representative of defects on the substrate and corresponds to an image capture condition of the reference image.
44. The computer-readable medium of clause 43, wherein determining the defect detection probability of the reference images includes:
   for each reference image of the image pairs,
      determining a defect score map that is indicative of a defect score of each pixel of the reference image, wherein the defect score is indicative of a probability of presence of a defect in the corresponding pixel;
      obtaining defect scores of portions of the reference image categorized as a defect; and
      obtaining defect scores of portions of the reference image categorized as a nuisance.
45. The computer-readable medium of clause 43, wherein selecting the subset of image pairs includes selecting those of the image pairs in which a reference image is associated with a defect score map having a defect score of a defect and a nuisance within a first range.
46. The computer-readable medium of clause 45, wherein the first range is representative of a defect score range in which the defect detection probability of a determining a defect from nuisance is below a specified threshold.
47. The computer-readable medium of clause 43, wherein training the neural network is an iterative process and each iteration includes:
   determining a difference between the predicted image the reference image;
   determining whether the difference is reduced; and
   responsive to a determination that the difference is not reduced, modifying parameters of the neural network and repeating an iteration.
48. The computer-readable medium of clause 43, wherein the first image corresponds to a first image capture condition, and the reference image corresponds to a second image capture condition.
49. The computer-readable medium of clause 48, wherein the first image is of a lower resolution than the reference image.
50. The computer-readable medium of clause 43 further comprising:
   inputting a specified image of a specified substrate captured in a first image capture condition to the neural network; and
   executing the neural network to generate a specified predicted image based on the specified image, the specified predicted image representative of defects on the specified substrate and corresponding to a second image capture condition.
51. A method for training a machine learning model to generate an image representing defects on a substrate, the method comprising:
   inputting a first image and a reference image representative of images captured using different image capture conditions to a neural network, the first image and the reference image indicate defects on a substrate patterned with a target layout;
   generating, using the neural network, a predicted image in response to the first image;
   computing a loss function that is indicative of a difference between a defect distribution in the predicted image and a defect distribution in the reference image; and
   modifying the neural network based on the loss function.
52. A method for training a machine learning model to generate an image representing defects on a substrate, the method comprising:
   inputting a first image and a reference image representative of images captured using different image capture conditions to a neural network, the first image and the reference image representative of defects on a substrate patterned with a target layout;
   generating, using the neural network, a predicted image in response to the first image;
   computing a loss function that is indicative of a difference between a first set of feature vectors of the predicted image and a second set of feature vectors of the reference image; and
   modifying the neural network based on the loss function.
53. An apparatus for training a machine learning model to generate an image representing defects on a substrate, the apparatus comprising:
   a memory storing a set of instructions; and
   a processor configured to execute the set of instructions to cause the apparatus to perform a method of:
      inputting a first image and a reference image representative of images captured using different image capture conditions to a neural network, the first image and the reference image indicate defects on a substrate patterned with a target layout;
      generating, using the neural network, a predicted image in response to the first image;
      computing a loss function that is indicative of a difference between a defect distribution in the predicted image and a defect distribution in the reference image; and
      modifying the neural network based on the loss function.
54. An apparatus for training a machine learning model to generate an image representing defects on a substrate, the apparatus comprising:
   a memory storing a set of instructions; and
   a processor configured to execute the set of instructions to cause the apparatus to perform a method of:
      inputting a first image and a reference image representative of images captured using different image capture conditions to a neural network, the first image and the reference image representative of defects on a substrate patterned with a target layout;
      generating, using the neural network, a predicted image in response to the first image;
      computing a loss function that is indicative of a difference between a first set of feature vectors of the predicted image and a second set of feature vectors of the reference image; and
modifying the neural network based on the loss function.

The descriptions herein are intended to be illustrative, not limiting. Thus, it will be apparent to one skilled in the art that modifications may be made as described without departing from the scope of the claims set out below.

1. A non-transitory computer-readable medium having instructions that, when executed by a computer system, cause the computer system to at least:
input a first image and a reference image representative of images captured using different image capture conditions to a neural network, the first image and the reference image indicate defects on a substrate patterned with a target layout;
generate, using the neural network, a predicted image in response to the first image;
compute a loss function that is indicative of a difference between a defect distribution in the predicted image and a defect distribution in the reference image; and
modify the neural network based on the loss function.

2. The computer-readable medium of claim 1, wherein the instructions configured to cause the computer system to compute the loss function are further configured to cause the computer system to:
determine the defect distribution in the predicted image as a predicted defect score map in which a defect score is indicative of a probability of presence of a defect in a portion of the predicted image;
determine the defect distribution in the reference image as a reference defect score map in which a defect score is indicative of a probability of presence of a defect in a portion of the reference image; and
compute a difference between the predicted defect score map and the reference defect score map.

3. The computer-readable medium of claim 2, wherein the defect score satisfying a threshold score is representative of a defect on the substrate in a location corresponding to the portion of the reference image.

4. The computer-readable medium of claim 3, wherein the instructions configured to cause the computer system to compute the loss function are further configured to cause the computer system to compute a difference between a first set of feature vectors of the predicted image and a second set of feature vectors of the reference image.

5. The computer-readable medium of claim 4, wherein the instructions configured to cause the computer system to compute the difference are further configured to cause the computer system to:
apply a feature extraction filter to the reference image to obtain the first set of feature vectors as a reference classifier feature map, which is representative of features of a defect or nuisance in the reference image;
apply the feature extraction filter to the predicted image to obtain the second set of feature vectors as a predicted classifier feature map, which is representative of features of a defect or nuisance in the predicted image; and
compute a difference between the reference classifier feature map and the predicted classifier feature map.

6. The computer-readable medium of claim 1, wherein the instructions configured to cause the computer system to compute the loss function are further configured to cause the computer system to compute a pixel-to-pixel difference between the predicted image and the reference image.

7. The computer-readable medium of claim 1, wherein the first image corresponds to a fast scan image capture condition of an image capture apparatus, and the predicted image and the reference image correspond to a slow scan image capture condition of the image capture apparatus.

8. The computer-readable medium of claim 7, wherein the first image is of a lower resolution than the reference image.

9. The computer-readable medium of claim 1, wherein the instructions configured to cause the computer system to input the first image and the reference image are further configured to cause the computer system to add a defect to the first image and the reference image.

10. The computer-readable medium of claim 9, wherein the instructions configured to cause the computer system to add the defect to the first image and the reference image are further configured to cause the computer system to edit a portion of the first image and the reference image to match with a portion of a specified image that is indicative of a defect on the substrate.

11. The computer-readable medium of claim 1, wherein the instructions configured to cause the computer system to input the first image and the reference image are further configured to cause the computer system to select a first image pair of multiple image pairs based on defect detection probability of reference images in the image pairs, wherein the first image pair includes the first image and the reference image.

12. The computer-readable medium of claim 11, wherein the instructions configured to cause the computer system to select the first image pair are further configured to cause the computer system to select those of the image pairs in which a reference image is associated with a defect score map having a defect score of a defect and a nuisance within a first range.

13. The computer-readable medium of claim 1, wherein the instructions are further configured to cause the computer system to:
input a specified image of a specified substrate captured in a fast scan image capture condition to the neural network; and
execute the neural network to generate a specified predicted image based on the specified image, the specified predicted image representative of defects on the specified substrate and corresponding to a slow scan image capture condition.

14. The computer-readable medium of claim 1, wherein the instructions are further configured to cause the computer system to modify an area of the reference image that is representative of a defect to generate an updated reference image to use for training the neural network.

15. The computer-readable medium of claim 14, wherein the instructions configured to cause the computer system to modify the area are further configured to cause the computer system to enhance contrast of the area of the reference image.

16. A non-transitory computer-readable medium having instructions that, when executed by a computer system, are configured to cause the computer system to at least:
obtain a first image and a reference image captured using different image capture conditions, the first image and the reference image representative of defects on a substrate patterned with a target layout;
add a defect to the first image and the reference image to generate an updated first image and an updated reference image; and
train a neural network to generate an image indicative of defects with the updated first image and the updated reference image to convert the updated first image to a predicted image using the updated reference image, wherein the predicted image is representative of defects on the substrate and corresponds to an image capture condition of the reference image.

17. The computer-readable medium of claim 16, wherein the instructions configured to cause the computer system to add the defect are further configured to cause the computer to system to edit a portion of the image to match with a portion of the reference image or the first image that is indicative of a defect on the substrate.

18. The computer-readable medium of clause 16, wherein the first image is of a lower resolution than the reference image.

19. A non-transitory computer-readable medium having instructions that, when executed by a computer system, are configured to cause the computer system to at least:
obtain a first image and a reference image captured using different image capture conditions, the first image and the reference image representative of defects on a substrate patterned with a target layout;
modify an area of the reference image that is representative of a defect to generate an updated reference image; and
train a neural network to convert the first image to a predicted image using the updated reference image, wherein the predicted image is representative of defects on the substrate and corresponds to an image capture condition of the reference image.

20. The computer-readable medium of claim 19, wherein the instructions configured to cause the computer system to modify the area of the reference image are further configured to cause the computer system to enhance a contrast of the area of the reference image.
